(19) United States
(12) Patent Application Publication
(10) Pub. No.: US 2026/0060182 A1
(43) Pub. Date: Mar. 5, 2026

(54) RECYCLING-FRIENDLY GARDENING SHEARS

(71) Applicant: JIIN HAUR INDUSTRIAL CO.,LTD., LU KANG TOWN (TW)

(72) Inventor: Shih-Piao Wu, LU KANG TOWN (TW)

(21) Appl. No.: 18/826,065

(22) Filed: Sep. 5, 2024

(51) Int. Cl. A01G 3/02

(52) U.S. Cl. CPC A01G 3/02

(57) ABSTRACT

Recycling-friendly gardening shears include a metallic unit and a nonmetallic unit. The metallic unit has metallic components. At least one of the metallic components has an engagement space. The nonmetallic unit has engaging portions. The metallic components are smoothly coupled to the nonmetallic unit as soon as the engagement spaces engage with the engaging portions. When the gardening shears are no longer usable and thus are suitable for recycling, a user only needs to exert a simple pull to separate the engaging portions quickly from the engagement spaces and thus conveniently detach the nonmetallic unit from the metallic components. The gardening shears include a metallic unit and a nonmetallic unit. The metallic unit has metallic components, such as a gardening shear body, resilient element, block, spring, and positioning pin. The nonmetallic unit has two pads, a buffer and a knob which are mounted on the gardening shear body.

### FIELD

The present disclosure relates to gardening shears for pruning and trimming branches and leaves, and more particularly to recycling-friendly gardening shears.

### BACKGROUND

Common, conventional gardening shears essentially comprise two blades. A handle is connected to each of the two blades and has a middle segment in which a penetrating hole is formed. The penetrating hole is penetrated by a screw. The screw is fastened in place with a nut, allowing the two blades to be pivotally fitted together and positioned in place. When a force is applied to the two handles, the penetrating hole serves as a pivoting point to allow the blades to be opened and closed to perform a cutting process. Each of the two handles is covered with a pad in a close-fitting manner to ensure an easy grip, bring a no-slip effect, and has a soft feel. Since the blades, the handles, the screw and the nut are made of metal, with the pads being made of a nonmetal, such as plastic and rubber, the recycling and reuse of the gardening shears necessitates separating the metallic blades, handles, screws and nuts from the nonmetallic pads completely.

The drawbacks of the conventional gardening shears in terms of recycling and reuse are described below. With the handles being covered with the pads in a close-fitting manner, the pads can be efficiently separated from metallic components, such as the handles, only after being deliberately damaged (for example, cut and then peeled off) – a laborious process which incurs high recycling cost and thus discourages recycling dealers from recycling the conventional gardening shears. As a result, the conventional gardening shears fail to keep pace with the global trend toward net-zero carbon emissions and thus are doomed to flagging sales, boycotts, and a weak competitive position.

As a result, there is still room for improvement in the prior art pertaining to the conventional gardening shears.

### SUMMARY

### Issue:

It is difficult to separate nonmetallic components of conventional gardening shears from metallic components of conventional gardening shears; thus, the recycling of conventional gardening shears is too difficult to be effective.

### Solution:

The disclosure provides recycling-friendly gardening shears comprising a metallic unit and a nonmetallic unit. The metallic unit has metallic components. At least one of the metallic components has an engagement space. The nonmetallic unit has engaging portions. The metallic components are smoothly coupled to the nonmetallic unit as soon as the engagement spaces engage with the engaging portions. When the gardening shears are no longer usable and thus are suitable for recycling, a user only needs to exert a simple pull to separate the engaging portions quickly from the engagement spaces and thus conveniently detach the nonmetallic unit from the metallic components. The gardening shears comprise a metallic unit and a nonmetallic unit. The metallic unit has metallic components, such as a gardening shear body, a resilient element, a block, a spring and a positioning pin. The nonmetallic unit comprises two pads, a buffer and a knob which are mounted on the gardening shear body. The gardening shear body has two handles pivotally connected to each other. A blade is connected to each of the two handles. Under a force applied to the two handles, the two blades are opened and closed to perform a cutting process. The engagement spaces are defined at multiple points on the two handles respectively. The resilient element is mounted in place between the two handles. One of the blades has a limitative notch. One of the handles has a slot in which the block, the spring and the positioning pin are mounted in place. When the two blades are closed, the knob coupled to the gardening shear body drives the block protruding out of the slot and then further entering the limitative notch to cause the blades to stay in a closed state. The positioning pin is pushed by the spring to preclude displacement of the block, and thus the block is fixed in place at a protruded position or a retracted position. The engaging portions are disposed on the pads, the buffer and the knob respectively. Owing to the resilience of the nonmetallic unit, the engaging portions compressed get fitted inside the engagement spaces respectively, allowing the pads, the buffer and the knob to be fully coupled to the gardening shear body. At this point in time, the recycling-friendly gardening shears of the disclosure achieve the objective of the disclosure.

Advantages of the disclosure over the prior art:

The disclosure provides recycling-friendly gardening shears. To recycle the gardening shears, a user only needs to exert a simple pull to separate the engaging portions quickly from the engagement spaces and thus conveniently detach the nonmetallic unit from the gardening shear body. The aforesaid detachment process dispenses with a damaging means and thus is conducive to the minimization of the difficulties in recycling, the required manpower and the incurred cost and the enhancement of recycling dealers’ incentive to recycle the gardening shears. When effectively recycled, the gardening shears can keep pace with the global trend toward net-zero carbon emissions and thus avoid flagging sales, boycotts, and a weak competitive position.

### BRIEF DESCRIPTION OF THE DRAWINGS

FIG. 1 is a perspective view of the disclosure.

FIG. 2 is an exploded view of the disclosure.

FIG. 3 is an assembled cross-sectional view of the disclosure.

FIG. 4 is an assembled cross-sectional view taken from another angle of the disclosure.

FIG. 5 is a first cross-sectional view of how to remove a nonmetallic unit of the disclosure.

FIG. 6 is a second cross-sectional view of how to remove the nonmetallic unit of the disclosure.

FIG. 7 depicts the complete separation of a metallic unit from the nonmetallic unit of the disclosure.

### DETAILED DESCRIPTION

Objectives, features, and advantages of the disclosure are herein illustrated with embodiments, depicted with drawings, and described below.

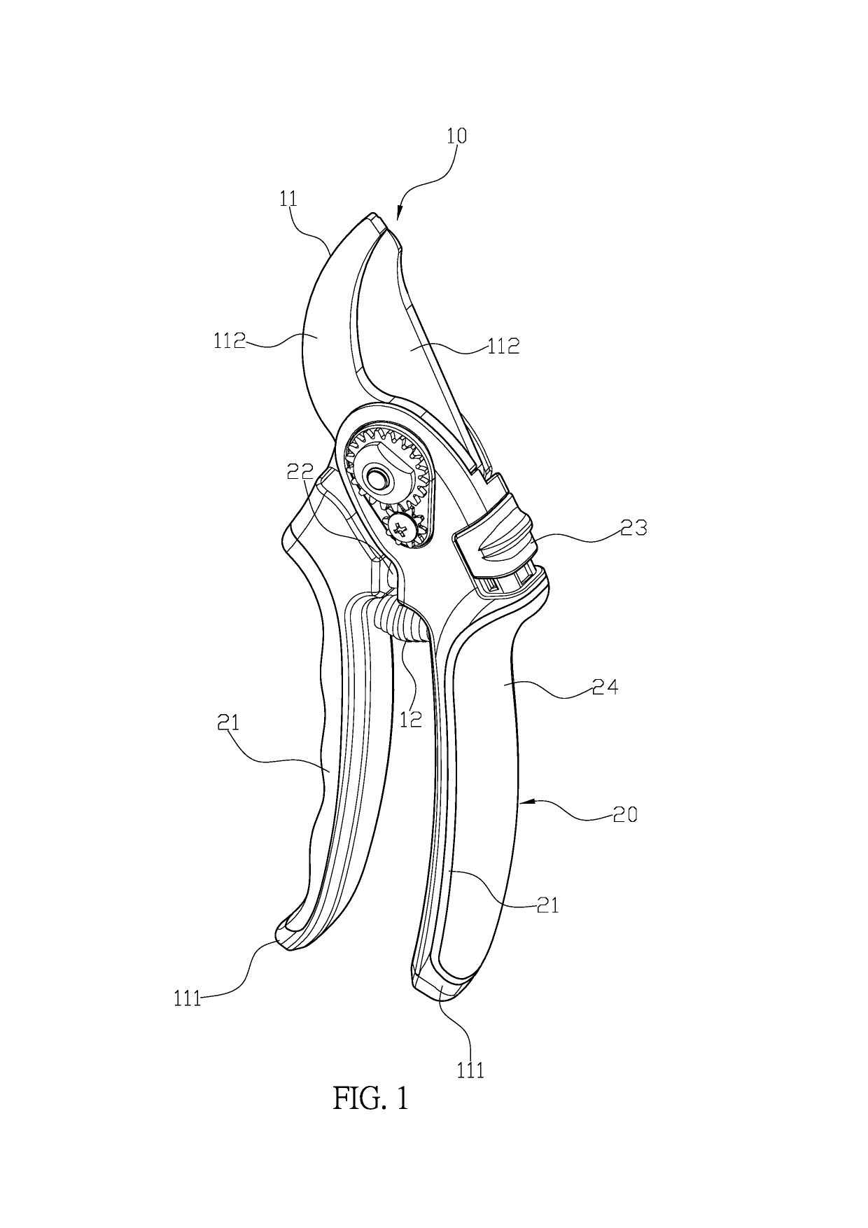

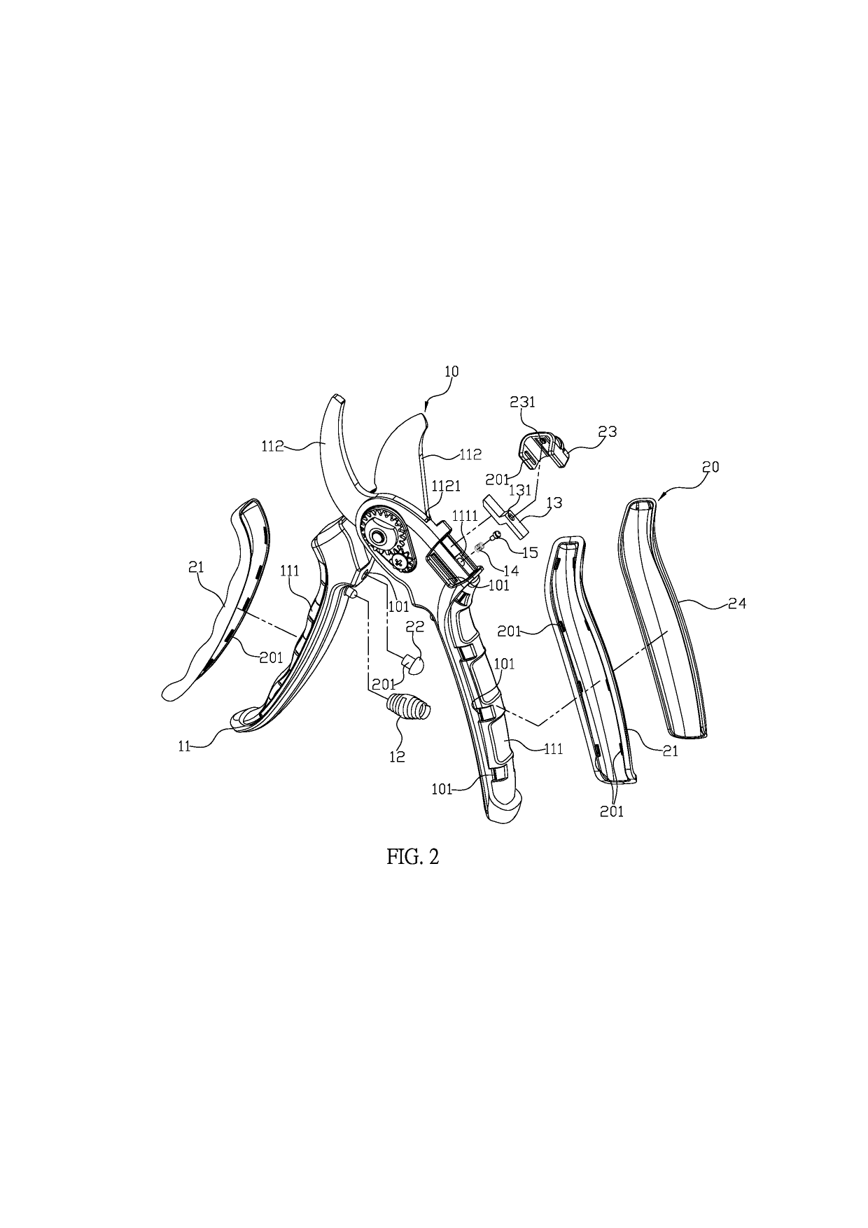

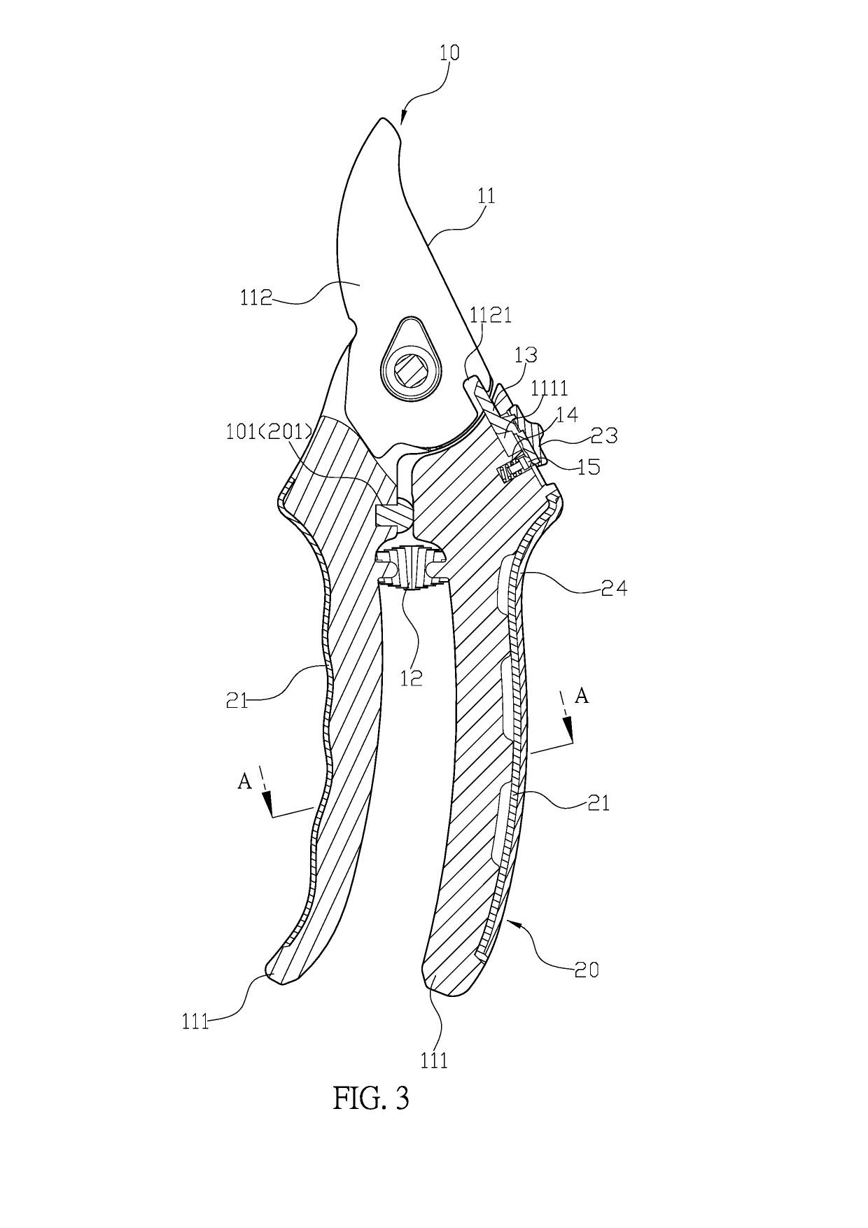

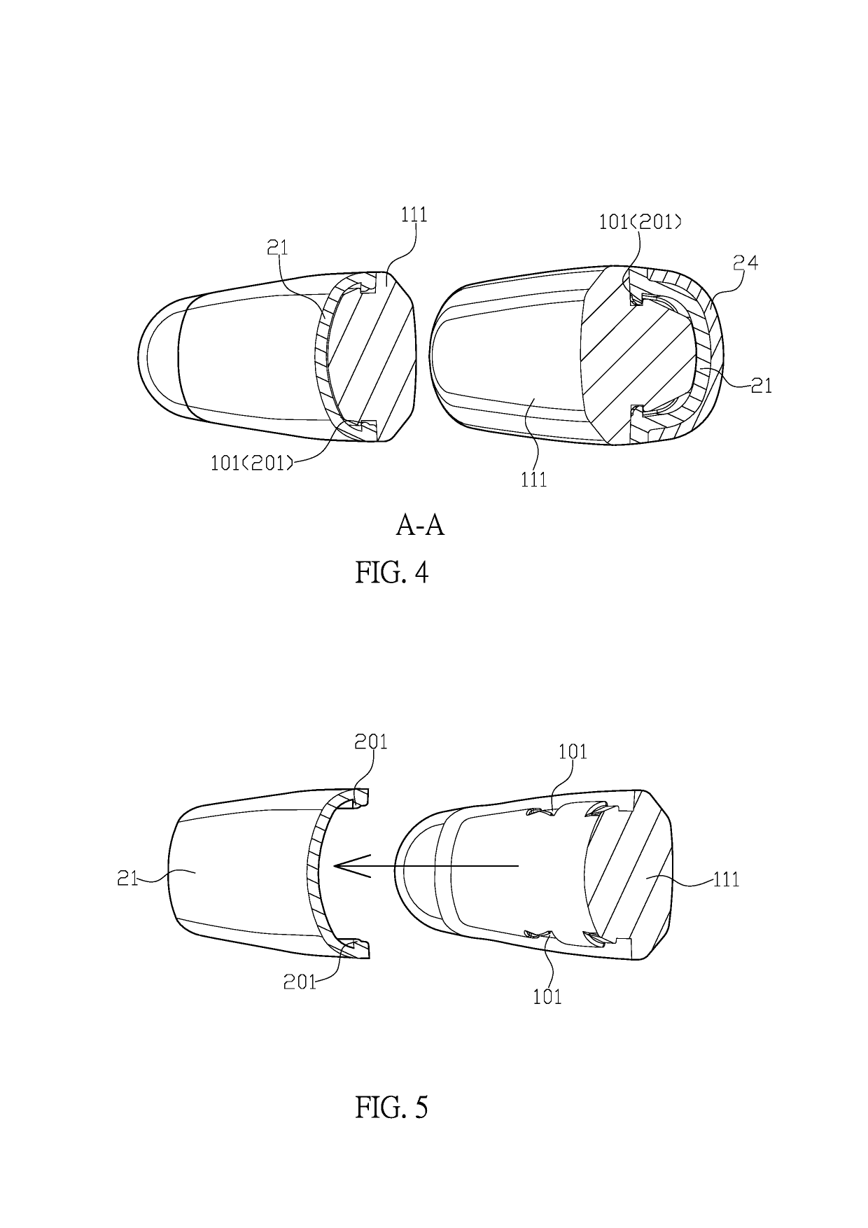

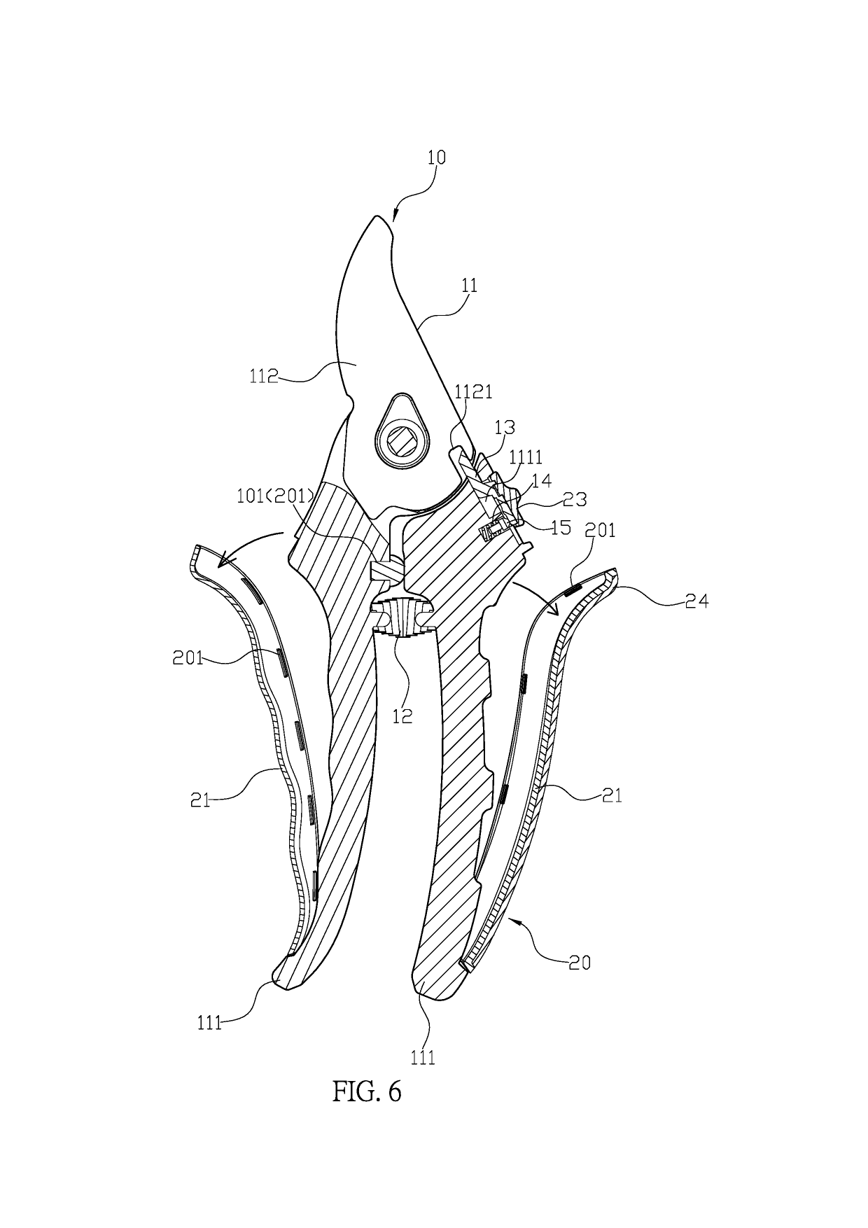

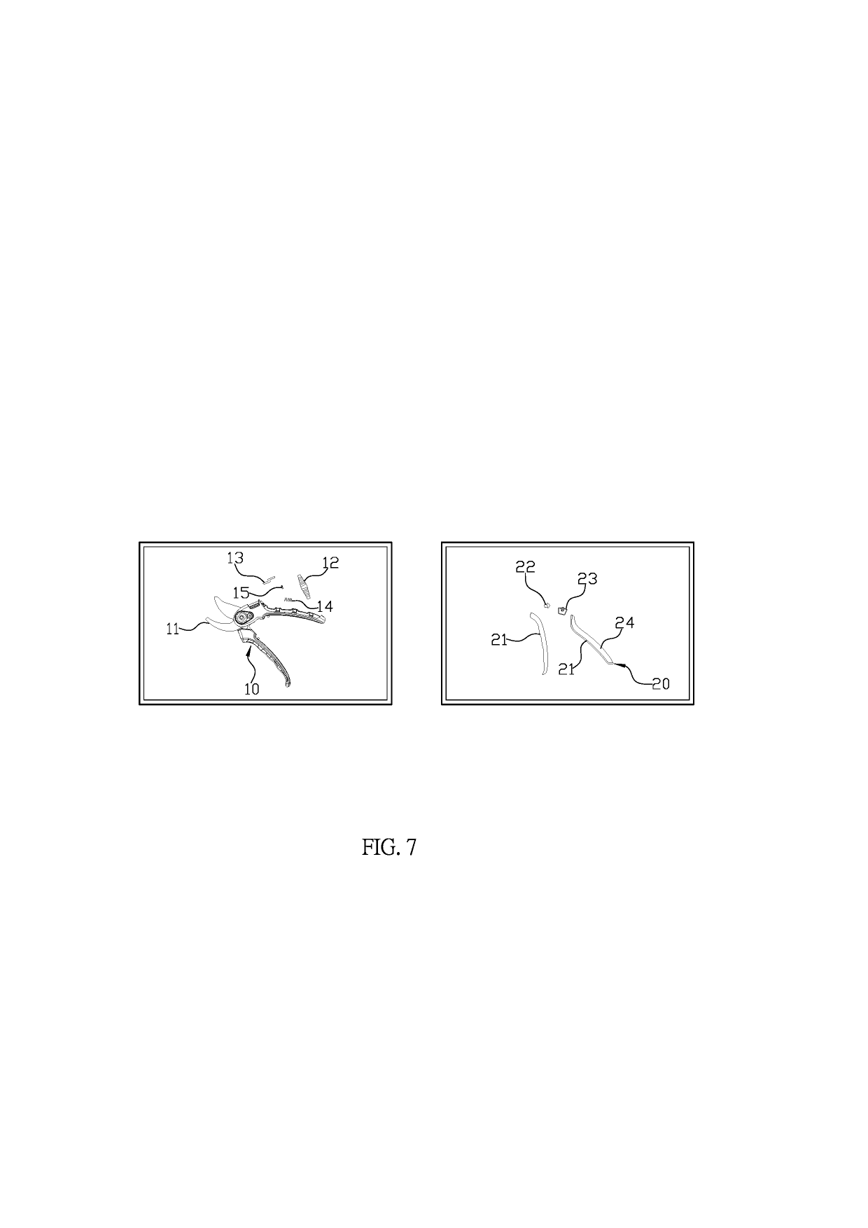

Referring to FIG. 1 through FIG. 4, the disclosure provides recycling-friendly gardening shears comprising a metallic unit (10) and a nonmetallic unit (20). The metallic unit (10) has metallic components. At least one of the metallic components has an engagement space (101). The nonmetallic unit (20) has engaging portions (201). The metallic components are smoothly coupled to the nonmetallic unit (20) as soon as the engagement spaces (101) engage with the engaging portions (201). When the gardening shears are no longer usable and thus are suitable for recycling, a user only needs to exert a simple pull to separate the engaging portions (201) quickly from the engagement spaces (101) and thus conveniently detach the nonmetallic unit (20) from the metallic components (as shown in FIG. 5 through FIG. 7). The metallic unit (10) comprises metallic components, such as a gardening shear body (11), a resilient element (12), a block (13), a spring (14) and a positioning pin (15). The nonmetallic unit (20) comprises two pads (21), a buffer (22) and a knob (23) which are mounted on the gardening shear body (11). The gardening shear body (11) has two handles (111) pivotally connected to each other. A blade (112) is connected to each of the two handles (111). Under a force applied to the two handles (111), the two blades (112) are opened and closed to perform a cutting process. The engagement spaces (101) are defined at multiple points on the two handles (111) respectively. The resilient element (12) is mounted in place between the two handles (111). One of the blades (112) has a limitative notch (1121). One of the handles (111) has a slot (1111) in which the block (13), the spring (14) and the positioning pin (15) are mounted in place. When the two blades (112) are closed, the knob (23) coupled to the gardening shear body (11) drives the block (13) protruding out of the slot (1111) and then further entering the limitative notch (1121) to cause the blades (112) to stay in a closed state. The positioning pin (15) is pushed by the spring (14) to preclude displacement of the block (13), and thus the block (13) is fixed in place at a protruded position or a retracted position. The engaging portions (201) are disposed on the pads (21), the buffer (22) and the knob (23) respectively. Owing to the resilience of the nonmetallic unit (20), the engaging portions (201) compressed get fitted inside the engagement spaces (101) respectively, allowing the pads (21), the buffer (22) and the knob (23) to be fully coupled to the gardening shear body (11).

The disclosure provides recycling-friendly gardening shears, wherein the resilient element (12) is a compression spring formed by winding a metal wire.

The disclosure provides recycling-friendly gardening shears, wherein the resilient element (12) is a barrel spring formed by winding a metal plate.

The disclosure provides recycling-friendly gardening shears, wherein the pads (21), the buffer (22) and the knob (23) are made of plastic.

The disclosure provides recycling-friendly gardening shears, wherein the pads (21), the buffer (22) and the knob (23) are made of rubber.

The disclosure provides recycling-friendly gardening shears, wherein the engaging portions (201) on the pads (21) are ribs, and the engagement spaces (101) for engaging with the engaging portions (201) are engaging grooves.

The disclosure provides recycling-friendly gardening shears, wherein the engaging portions (201) on the buffer (22) are engaging posts, and the engagement spaces (101) for engaging with the engaging portions (201) are engaging holes.

The disclosure provides recycling-friendly gardening shears, wherein the engaging portions (201) on the knob (23) are ribs, and the engagement spaces (101) for engaging with the engaging portions (201) are engaging grooves. The engaging grooves are larger than the knob (23), allowing the knob (23) to be pushed to undergo translational motion after having engaged with the handles (111).

The disclosure provides recycling-friendly gardening shears characterized in that the outer surface of at least one of the pads (21) is covered with a vibration-absorbing layer (24) to enhance the comfortableness of the gardening shear body (11).

The disclosure provides recycling-friendly gardening shears characterized by a positioning post (231) disposed on the knob (23) and a positioning hole (131) disposed on the block (13), with the positioning post (231) penetratingly fixed to the positioning hole (131), such that the knob (23) and the block (13) are linked to each other, allowing the knob (23) to drive the block (13) undergoing translational motion.

The advantages of the aforesaid specific embodiment are described below. To recycle the gardening shears, a user only needs to exert a simple pull to separate the engaging portions (201) quickly from the engagement spaces (101) and thus conveniently detach the nonmetallic unit (20) from the gardening shear body (11). The aforesaid detachment process dispenses with a damaging means and thus is conducive to the minimization of the difficulties in recycling, the required manpower and the incurred cost and the enhancement of recycling dealers’ incentive to recycle the gardening shears. When effectively recycled, the gardening shears can keep pace with the global trend toward net-zero carbon emissions and thus avoid flagging sales, boycotts, and a weak competitive position.

In conclusion, the disclosure provides radical innovation and thus improves on the prior art. In addition, the disclosure has high industrial applicability and involves an inventive step. Furthermore, the disclosure has never been published and has novelty.

The disclosure is disclosed above by preferred embodiments. However, persons skilled in the art should understand that the embodiments are illustrative of the disclosure only, but shall not be interpreted as restrictive of the scope of the disclosure. Please note that all variations and modifications equivalent to the embodiments shall be deemed falling within the scope of the disclosure.

What is claimed is:

1. Recycling-friendly gardening shears, comprising a metallic unit and a nonmetallic unit, the metallic unit having metallic components, with an engagement space defined on at least one of the metallic components, the nonmetallic unit having engaging portions, the metallic components being smoothly coupled to the nonmetallic unit as soon as the engagement spaces engage with the engaging portions, wherein, when the gardening shears are no longer usable and thus are suitable for recycling, a user only needs to exert a simple pull to separate the engaging portions quickly from the engagement spaces and thus conveniently detach the nonmetallic unit from the metallic components, the metallic components comprising a gardening shear body, a resilient element, a block, a spring and a positioning pin, and the nonmetallic unit further having two pads, a buffer and a knob which are mounted on the gardening shear body,
wherein the gardening shear body has two handles pivotally connected to each other, with a blade connected to each of the two handles, with the two blades opened and closed under a force applied to the two handles to perform a cutting process, with the engagement spaces defined at multiple points on the two handles respectively, with the resilient element mounted in place between the two handles, with a limitative notch disposed on one of the blades, wherein one of the handles has a slot in which the block, the spring and the positioning pin are mounted in place, wherein, when the two blades are closed, the knob coupled to the gardening shear body drives the block protruding out of the slot and then further entering the limitative notch to cause the blades to stay in a closed state, wherein the positioning pin is pushed by the spring to preclude displacement of the block, and thus the block is fixed in place at a protruded position or a retracted position,
wherein the engaging portions are disposed on the pads, the buffer and the knob respectively, wherein, owing to resilience of the nonmetallic unit, the engaging portions compressed get fitted inside the engagement spaces respectively, allowing the pads, the buffer and the knob to be fully coupled to the gardening shear body.

2. The recycling-friendly gardening shears of claim 1, wherein the resilient element is a compression spring formed by winding a metal wire.

3. The recycling-friendly gardening shears of claim 1, wherein the resilient element is a barrel spring formed by winding a metal plate.

4. The recycling-friendly gardening shears of claim 1, wherein the engaging portions on the pads are ribs, and the engagement spaces for engaging with the engaging portions are engaging grooves.

5. The recycling-friendly gardening shears of claim 1, wherein the engaging portions on the buffer are engaging posts, and the engagement spaces for engaging with the engaging portions are engaging holes.

6. The recycling-friendly gardening shears of claim 1, wherein the engaging portions on the knob are ribs, and the engagement spaces for engaging with the engaging portions are engaging grooves.

7. The recycling-friendly gardening shears of claim 1, wherein an outer surface of at least one of the pads is covered with a vibration-absorbing layer.

8. The recycling-friendly gardening shears of claim 1, wherein a positioning post is disposed on the knob, and a positioning hole is disposed on the block, with the positioning post penetratingly fixed to the positioning hole, such that the knob and the block are linked to each other, allowing the knob to drive the block undergoing translational motion.
